(19) United States
(12) Patent Application Publication
(10) Pub. No.: US 2010/0276347 A1
(43) Pub. Date: Nov. 4, 2010

(54) PORTABLE WATER PURIFICATION DEVICE

(75) Inventor: Zhanfeng Cui, Oxford (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ISIS INNOVATION LIMITED, Oxford (GB)

(21) Appl. No.: 12/682,556

(22) PCT Filed: Oct. 8, 2008
(86) PCT No.: PCT/GB08/03394

§ 371 Date: Jul. 8, 2010

(30) Foreign Application Priority Data
Oct. 12, 2007 (GB) 0719983.9
Aug. 26, 2008 (GB) 0815481.7

(51) Int. Cl. C02F 1/44; B01D 61/12

(52) U.S. Cl. 210/97; 210/321.69

(57) ABSTRACT

A gravity driven portable water purification device (1) comprises a dirty water inlet (5) operative to comprise a head of dirty water, water filtration means (23) connected to the dirty water inlet (5), and a clean water tank (35) connected to an outlet of the water filtration means (23). The dirty water inlet (5), when the device (1) is in an operational condition, is arranged relative to the clean water tank (35) and the water filtration means (23) such that, in use of the device, dirty water is forced through the water filtration means (23) and into the clean water tank (35) by the gravitational force generated from the head of dirty water in the dirty water inlet (5). The water filtration means (23) comprises a cross-flow membrane filter in which the gravitational force from the head of dirty water also forces dirty water across the cross-flow membrane filter so as to force contaminants out of the filter.

The present invention relates to a portable water purification device and particularly but not exclusively relates to a portable water purification device for use in emergency zones.

In emergency zones such as areas affected by floods for example, people can be trapped or isolated without drinking water and without electricity. In survival situations and in some military situations drinking water may not be available. It can often be the case that water is abundant but contaminated and thus not safely drinkable. In many situations the infrastructure of water purification, such as a mains water supply system, is destroyed, and the ability to transport in bottled or bagged clean drinking water is limited.

It has been proposed to provide single or low use water purification devices that are disposed of after a single throughput of fluid. Such devices use a dead-end filter wherein all the fluid passes through the membrane filter, and all particles larger than the pore size of the membrane are retained at its surface. This means that the retained particles start to build up on the surface of the membrane such that the membrane pores become blocked. This blinding reduces the efficiency of the filtration process and eventually means that no more fluid can be filtered.

It is desirable to be able to provide a clean water supply to cover the period before the mains water supply system can be re-established. Such a supply should be relatively reliable and simple to use in operation and ideally require no external power supply. Such devices should be able to remove particulates, bacteria, viruses and most organic matter and previously it has been considered that relatively high fluid pressure has been required to achieve this. For example filtration water purification devices are commercially available (for example, the MWP water purifier) which do not use mains power, but which rely on an operator hand pumping to pressurise the system.

According to a first aspect of the invention there is provided a portable water purification device comprising a dirty water inlet operative to comprise a head of dirty water, water filtration means connected to the dirty water inlet, and a clean water tank connected to an outlet of the water filtration means, the dirty water inlet, when the device is in an operational condition, being arranged relative to the clean water tank and the water filtration means such that, in use of the device, dirty water is forced through the water filtration means and into the clean water tank by the gravitational force generated from the head of dirty water in the dirty water inlet, the water filtration means comprising a cross-flow membrane filter in which the gravitational force from the head of dirty water also forces dirty water across the cross-flow membrane filter so as to force contaminants out of the filter.

Preferably the device comprises a dirty water inlet tank that feeds, in use, dirty water to the dirty water inlet.

Preferably the dirty water inlet tank and the clean water tank comprise internal reinforcement means.

Preferably the shape of the dirty water inlet tank substantially mirrors that of the clean water tank such that the device is substantially balanced in normal use.

Preferably the device comprises a clean water supply pipe connected to the clean water tank and operative to enable clean water to be discharged from the clean water tank.

Preferably the clean water supply pipe is flexible and capable of being positioned such that its free end is above the waste water level when in an operational condition.

Preferably the clean water tank comprises venting means operative to relieve pressure build up within the clean water tank.

Preferably the venting means comprises a venting tube connected between the clean water tank and the clean water supply pipe.

Preferably the dirty water inlet and the clean water tank are arranged such that when the clean water tank is full of clean water, the flow of dirty water through the filter of the water filtration means to the clean water tank automatically stops.

Preferably the dirty water inlet tank comprises a base which is inclined when the device is in an operational condition such that particles of matter suspended in the dirty water flow down the base so as to be separated from the water.

Preferably the base is inclined between 5° and 85° from the horizontal when the device is in an operational condition.

Preferably the base is inclined between 20° and 70° from the horizontal when the device is in an operational condition.

Most preferably the base is inclined at between 30° and 60° from the horizontal when the device is in an operational condition.

Preferably the device comprises a sump into which, in use, the separated particles collect.

Preferably the sump is positioned below the dirty water inlet to the water filtration means.

Preferably the sump is provided with a sump outlet that functions, in use, as a flow restrictor operative to enable continuous but controlled outlet of the separated particles from the sump.

The sump outlet may be adjustable for different flow rates.

In one embodiment the dirty water inlet is positioned below the lower end of the base of the dirty water inlet tank.

Preferably the dirty water inlet is positioned below a constriction of the dirty water inlet tank, the constriction being operative to induce a converging flow of dirty inlet water after the constriction so as to minimise the ingress of suspended particles entering the dirty water inlet of the water filtration means.

In another embodiment the dirty water inlet is positioned above the lower end of the base such that in use separated particles flow down the base and the remaining water flows up the base and into the dirty water inlet.

Preferably the base of the dirty water inlet tank comprises a particle separator comprising an inclined planar element spaced above the base so as to define a channel therebetween, the dirty water inlet being open to the channel.

Preferably the device further comprises back wash means connected between the clean water tank and the water filtration device and operative to force clean water back through the water filtration device to dislodge trapped particles from the water filtration device.

Preferably the back wash means comprises a bladder, compression of the bladder forcing clean water through the water filtration device.

Preferably the bladder is conical.

Preferably the water filtration means comprises a hollow fibre membrane type filter mounted in an elongate filter housing.

Preferably the filter is formed from a membrane material having a continuous operational life span of less than three months.

The filter housing may be mounted horizontally, when the device is in an operational condition.

The filter housing may be mounted vertically, when the device is in an operational condition.

The filter housing may be mounted at an angle inclined from the horizontal, when the device is in an operational condition.

Preferably the dirty water inlet and the clean water tank are formed from a flexible plastics material.

Preferably the device is collapsible.

Preferably the device can be collapsed by folding the device onto itself.

Preferably the device can be collapsed by furling the device onto itself.

Preferably the device comprises a bag.

Preferably the bag is substantially rectangular when in an operational condition.

Other aspects of the present invention may include any combination of the features or limitations referred to herein.

The present invention may be carried into practice in various ways, but embodiments will now be described by way of example only with reference to the accompanying drawings in which:

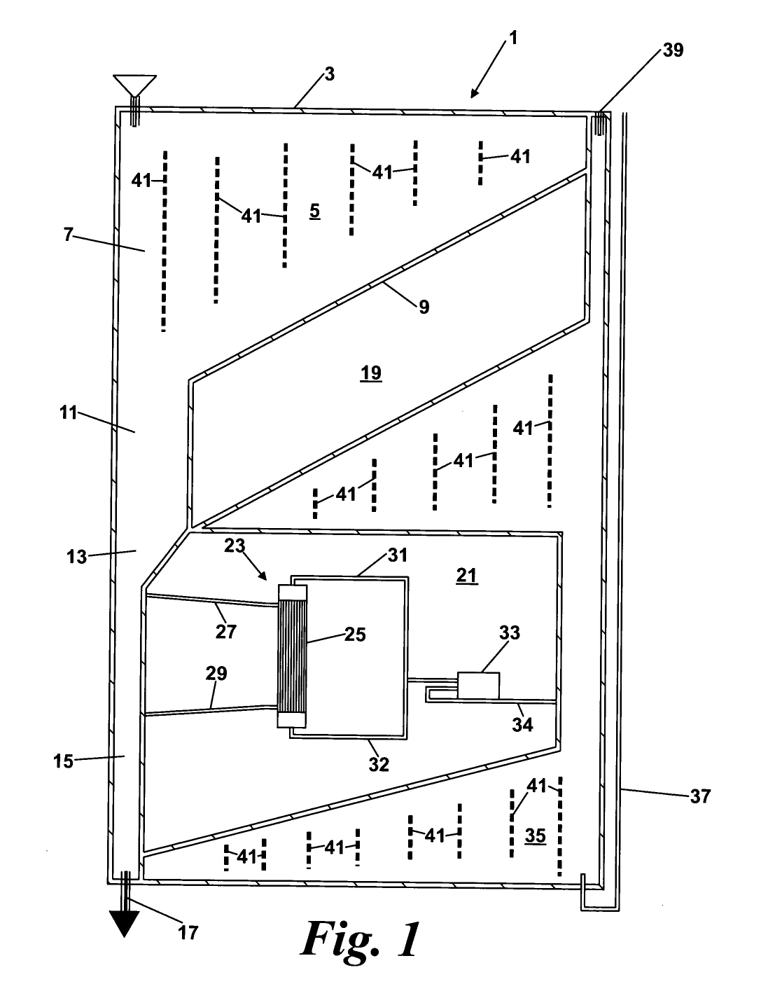

FIG. 1 is a schematic sectional side view of a device in accordance with the present invention;

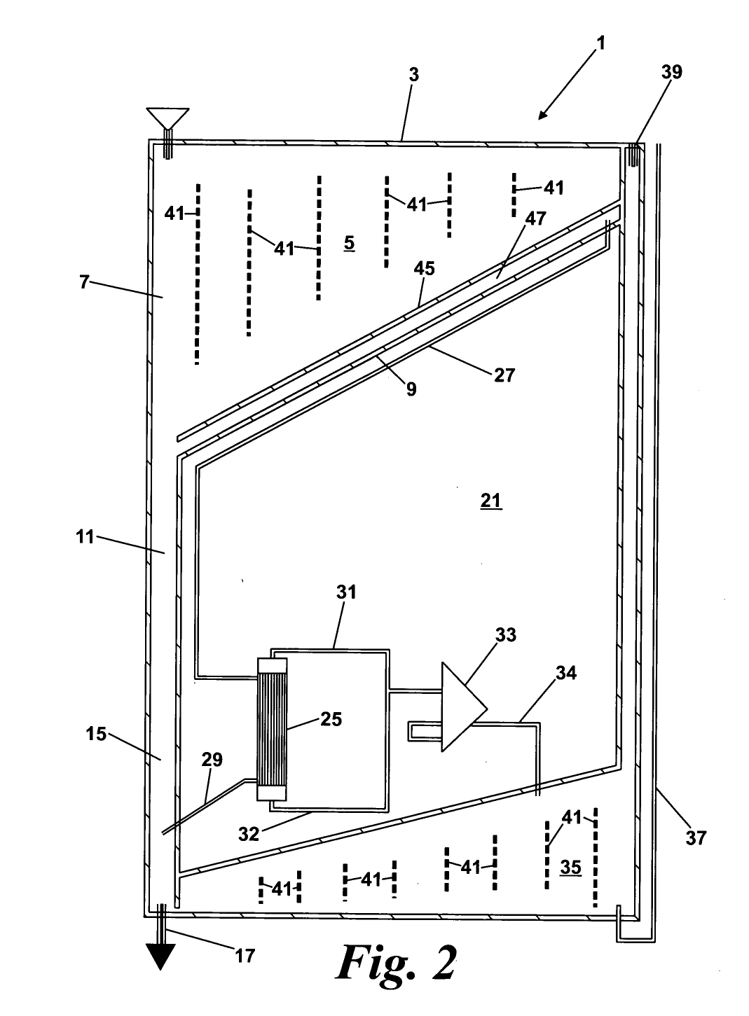

FIG. 2 is a schematic sectional side view of a modified device in accordance with the present invention;

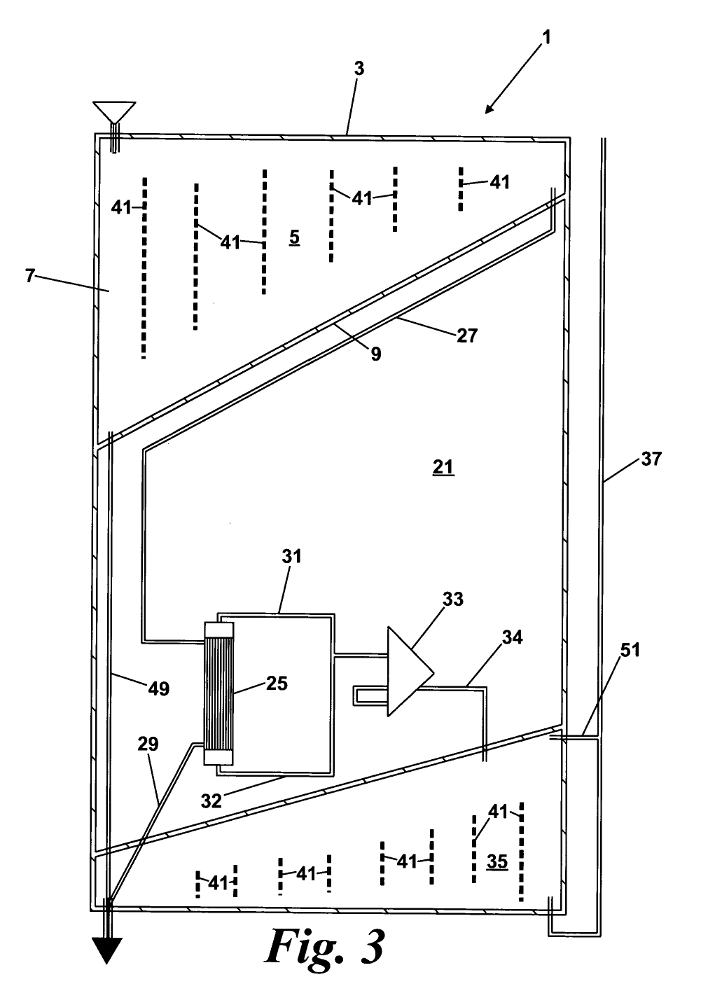

FIG. 3 is a schematic sectional side view of another modified device in accordance with the present invention;

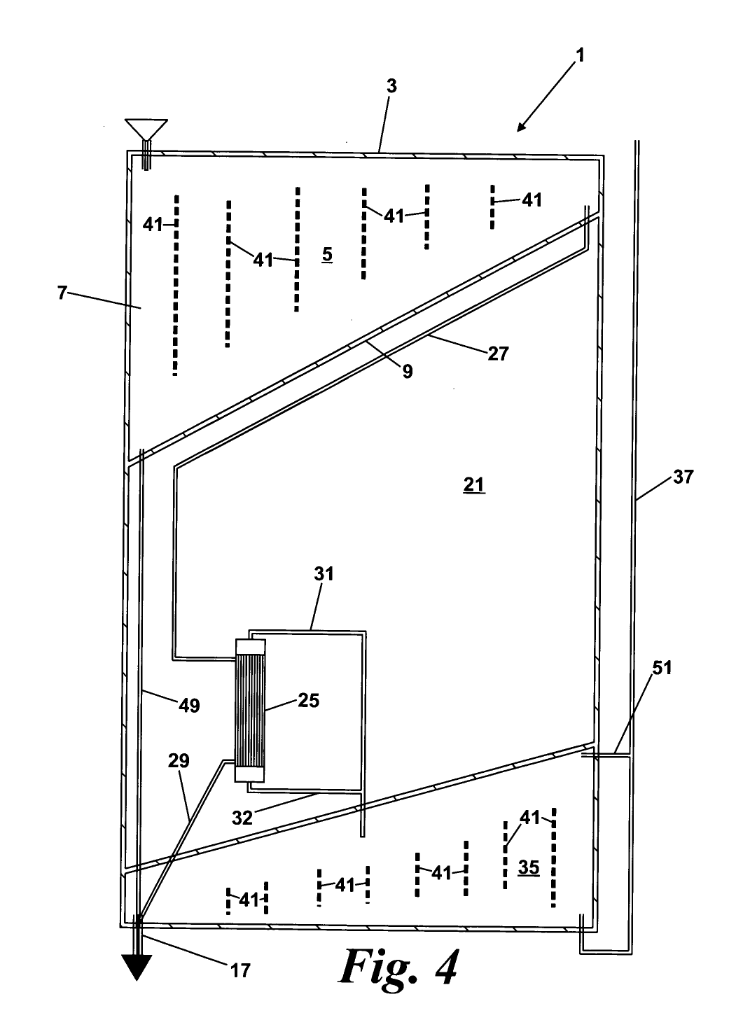

FIG. 4 is a schematic sectional side view of a further modified device in accordance with the present invention;

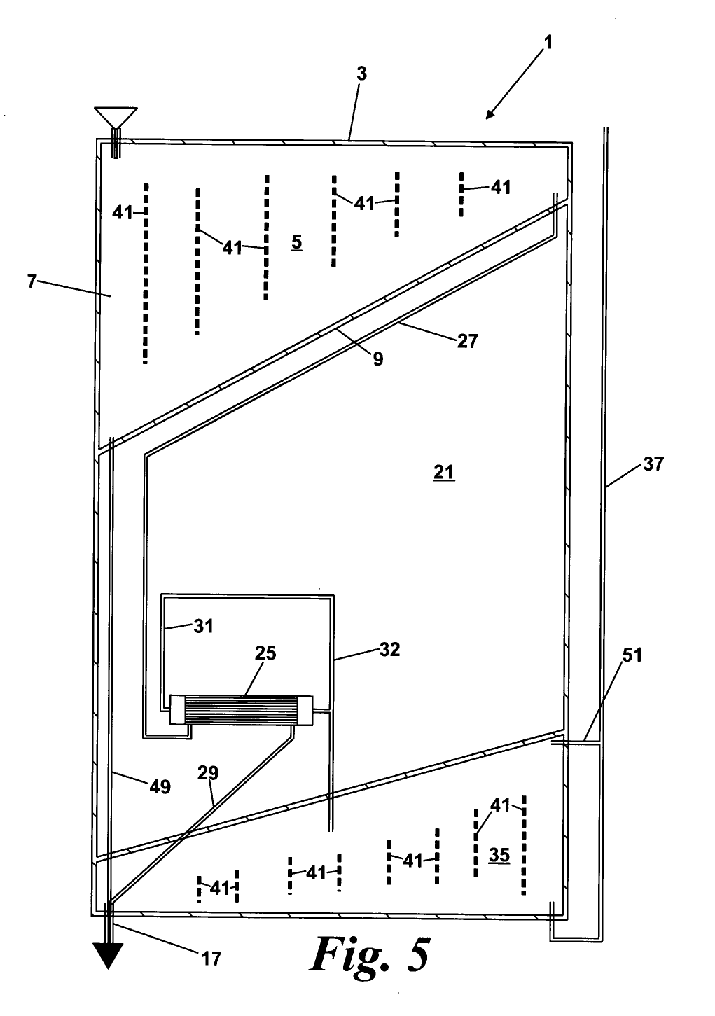

FIG. 5 is a schematic sectional side view of another modified device in accordance with the present invention;

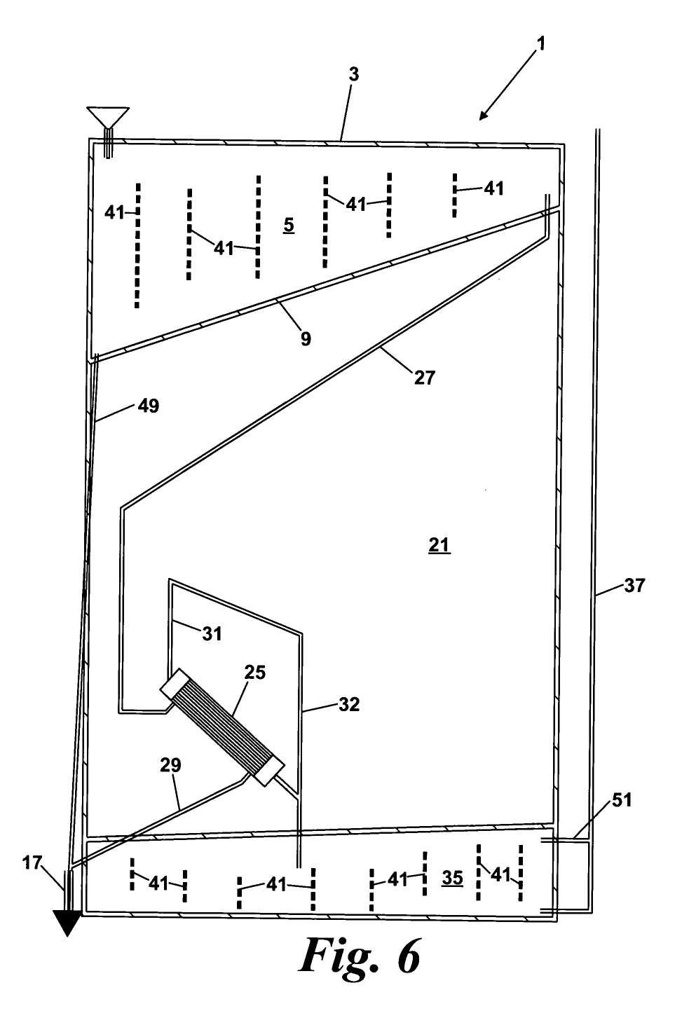

FIG. 6 is a schematic sectional side view of a further modified device in accordance with the present invention; and

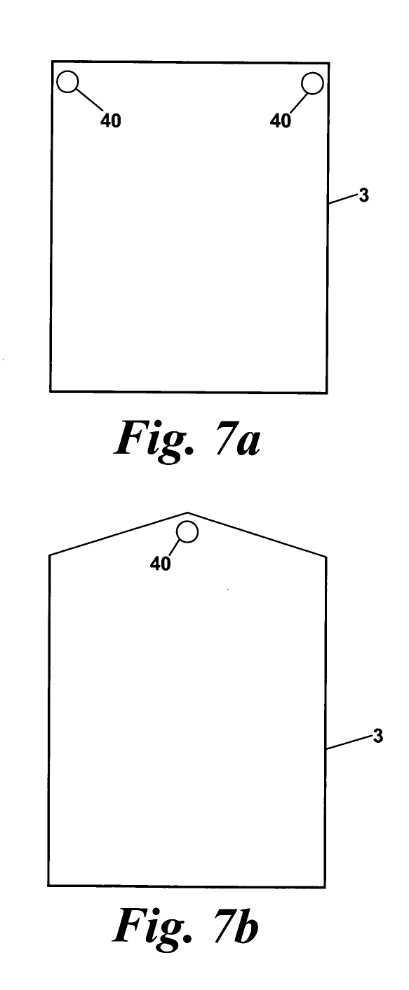

FIGS. 7a and 7b are schematic views of a device in accordance with the present invention with different mounting points.

Referring initially to FIG. 1, a portable water purification device 1 comprises a housing in the form of a rectangular plastic bag 3 formed from two rectangles of flexible sheet plastic material that have been sealed together about their periphery using, for example, a plastic weld, or adhesive. The bag 3 thus comprises an internal cavity which has been split into four compartments again, for example, using a plastic weld or adhesive.

The first compartment is a dirty water inlet tank 5 and comprises an upper tank portion 7 at the top of the bag 3 formed with a base 9 that inclines downwardly from right to left of the bag 3 as viewed in the figure. The lowermost margin of the base 9 leads to an intermediate oblong tank portion 11 that extends down one side of the bag 3 and which terminates in a constriction 13 that reduces the cross sectional area of the oblong tank portion 11. The constriction 13 leads to a sump 15, the sump 15 being provided with a sump outlet 17.

The second compartment 19 is located directly below the base 9 of the first compartment 5 and comprises an optional empty space which in this example is a parallelogram when viewed from the side of the bag 3.

The third compartment 21 comprises a space in which water filtration means 23 is mounted.

The water filtration means 23 comprises a cross-flow hollow fibre membrane type filter mounted in an elongate cylindrical filter housing 25. In this example the cylindrical filter housing 25 is mounted vertically within the third compartment 21. A dirty water inlet in the form of pipe 27 extends from just below the constriction 13 in the dirty water inlet tank 5 to one side of the filter. A dirty water outlet pipe 29 extends from a lower part of the cylindrical filter housing 25 to the sump 15. Clean water outlet pipes 31, 32 extend from respective ends of the filter housing 25 and lead to back wash means comprising a compressible bladder 33. A clean water pipe 34 extends from the bladder 33 to the fourth compartment that comprises a clean water tank 35. The connection from bladder 33 to pipe 34 incorporates a one-way valve which closes when bladder 33 is squeezed.

In this embodiment the clean water tank 35 extends across the bottom of the bag 3, up one side, and across the top of the third compartment 21, the ceiling of the clean water tank 35 being formed by the underside of the second compartment 19. A flexible clean water supply pipe 37 extends from the base of the clean water tank 35 and can be positioned in use up one side of the bag 3, as shown, so as to terminate above the level of the waste water in tank 5. The clean water tank 35 comprises venting means in the form of a vent channel 39 that outlets at the top margin of the bag 3.

In use, the device 1 is hung off a suitable item such as a tree, fence or wall for example, using a mounting point or points provided on the upper margin of the bag 3. The mounting points 40 may, for example, be at each upper corner of the bag 3 as shown in FIG. 7a, or may comprise a single central mounting point as shown in FIG. 7b.

Dirty water is then poured into the dirty water inlet tank 5. The dirty water initially collects in the sump 15 and heavier particles in the water settle to the bottom of the sump 15 and leave the bag 3 through the sump outlet 17. The dirty water rises up sump 15, up the intermediate oblong tank portion 11, past the constriction 13 and fills the upper tank portion 7 by flowing up the inclined base 9 of the upper compartment 5. During this process, the heavier particles slide down the inclined base 9 and into the sump 15 leaving cleaner water to rise up the inclined base 9 to fill the upper tank portion 7. So during this process the heavier particles drop into the sump 15 and flow out of the bag 3 through the sump outlet 17.

The partially cleaned water and the separated heavier particles then flow down the intermediate oblong tank portion 11 and past the constriction 13. The constriction 13 serves to create a converging fluid flow that minimises the ingress of the separated heavier particles into the dirty water inlet pipe 27 and the cylindrical filter housing 25.

The partially cleaned water is forced, by the gravitational force generated by the head of dirty water in the dirty water inlet tank 5, along the dirty water inlet pipe 27 and into the cylindrical filter housing 25, and within the limit of the mechanical strength of the filter material. The head of dirty water forces the partially cleaned water across the cross-flow membrane filter so as to remove the other essential contaminants from the water. These contaminants are forced out of the filter by the head of dirty water, along dirty water outlet pipe 29 and into the sump 15. Thus, a flow of dirty water is maintained over the membrane surface so as to flow in a direction parallel to the membrane surface. Some of the dirty water is forced through the membrane filter which filters out the contaminants. Some of the dirty water is forced tangentially across the membrane so as to rub off the filtered contaminants. These contaminants are carried out of the filter housing 25 through dirty water outlet pipe 29 and into the sump 15. Thus, not all of the dirty water input to the cylindrical filter housing 25 is recovered as filtered water. Use of a proportion of the dirty water to remove filtered contaminants from the membrane surface helps to prevent blocking of the membrane and thus increases the useful life of the device 1.

The cleaned water is forced along the clean water outlet pipes 31, 32 at each end of the cylindrical filter housing 25, into the bladder 33, along the clean water pipe 34 and into the clean water storage tank 35. The cleaned water can then be obtained using the clean water supply pipe 37.

It will therefore be appreciated that the dirty water is cleaned without the need for a pump or any power supply—the dirty water is forced through the filter using only the gravitational forces generated by the head of dirty water in the dirty water inlet pipe 27 as provided by the dirty water in the dirty water tank 5.

The volumes and relative heights of the dirty water tank 5 and the clean water tank 35 are chosen such that when the clean water tank 35 is full, the head of dirty water in the dirty water tank 5 is not sufficient to force further dirty water through the filter and into the clean water tank 35. So the device 1 is self regulating in the sense that the clean water tank 35 cannot overfill.

Likewise the sump outlet 17 is selected to ensure that the heavier particles continuously flow from the sump 15 without the need for a valve or any intervention from an operator. The continuous flow reduces the likelihood of the particles settling and blocking the sump outlet 17.

The shape and volume of the dirty water tank 5 and clean water tank 35 are selected such that when both are full the bag 3 is substantially balanced so as to hang with the sides of the bag 3 substantially vertical.

The dirty water tank 5 and the clean water tank 35 are each reinforced by the front and rear surfaces thereof being welded or adhered together along a plurality of discrete reinforcement lines 41.

Over time the filter may become partially or fully blocked by particles separated from the water. In this instance the bladder 33 may be utilised to back wash the filter with clean water from the bladder 33. This is achieved by a person squeezing the bladder 33 which automatically closes the clean water pipe 34 between the bladder 33 and the clean water storage tank 35 and forces clean water from the bladder 33 back into the filter. This clean water washes the particles from the filter and forces the blocking particles to mix with the water from the dirty water inlet pipe 27 in the filter and to flow out along the dirty water outlet pipe 29 and into the sump 15.

Referring to FIG. 2, a modified bag 3 is shown with like features being given like references. In this embodiment the empty second compartment is omitted, as is the constriction 13. The sump 15 instead is of substantially constant cross section and extends all the way to the lower margin of the base 9 of the upper tank portion 7. An inclined planar separator 45 is provided in the upper compartment 5 and is spaced apart from the base 9 so as to define a channel 47 therebetween.

In this embodiment the dirty water inlet pipe 27 to the filter extends from an upper part of the inclined base 9 and is located within the third compartment 21 in which the filter is housed. Thus in this embodiment the dirty water inlet pipe 27 does not extend from the sump 15 to the filter.

In this embodiment the bladder 33 is conical.

In use of this modified bag 3, as the sump 15 and upper compartment 5 fill with dirty water the heavier particles slide down the separator 45 and into the sump 15 with the remaining partially cleaned water flowing up the base 9 of the upper tank portion 7 and being subsequently forced, by the head of dirty water in the upper compartment 5, into the dirty water inlet pipe 27 located adjacent an uppermost part of the base 9.

Thus enhanced separation of the heavier particles from the dirty water is achieved so as to minimise the flow of the heavier particles into the filter.

In this embodiment the dirty water outlet pipe 29 between the filter and the sump 15 is chosen to control the flow rate of water through the filter, for example by selection of the pipe diameter. A narrower pipe will result in higher water recovery volume through the clean water pipe 34. The diameter of the pipe is for example up to 15 cm, such as 15, 10, 7, 5, 4, 3, 2, 1, 0.5 or 0.25 cm.

Referring to FIG. 3, a further modified bag 3 is provided wherein the sump 15 comprises a sump tube 49 extending from a lower part of the inclined base 9 to the bottom of the bag 3. The dirty water outlet pipe 29 from the filter connects with the sump tube 49. The dirty water inlet pipe 27 to the filter extends from an upper part of the inclined base 9 and though the third compartment 21. The cross sectional area of the sump tube 49 is selected to control the flow rate of discharge water through the tube and so the flow rate of water through the filter and into the clean water tank 35. The cross sectional area of the sump tube 49 is for example up to 15 cm, such as 15, 10, 7, 5, 4, 3, 2, 1, 0.5 or 0.25 cm.

In this embodiment the venting means of the clean water tank 35 comprises a vent tube 51 that exits the clean water tank 35 and extends up the side of the bag 3.

Referring to FIG. 4 a modified bag 3 is provided wherein the back wash means is omitted.

Referring to FIG. 5, a modified bag 3 is shown wherein the back wash means is omitted and the cylindrical filter housing 25 is orientated substantially horizontally.

Referring to FIG. 6, a modified bag 3 is provided wherein the back wash means is omitted, and the cylindrical filter housing 25 is inclined relative to the horizontal bottom of the bag 3 at about 45°. In this embodiment, the shape of the clean water tank 35 has been simplified so as to be substantially oblong. In this embodiment the sump tube 49 is extends through the wall of the bag 3.

It will be appreciated that the cylindrical filter housing 25 could be mounted at any desired orientation in any of the embodiments described above, and could be positioned higher or lower than shown in the Figures, as desired to obtain the desired flow rate of water through the filter.

Furthermore the above described embodiments are exemplary only and it is envisaged that any embodiment could be modified to include a feature or features from another embodiment.

In a preferred embodiment the device 1 uses a cross-flow hollow fibre membrane having a surface area of typically less than 5 m². The membrane pore size would typically be in the ultrafiltration range of 1 nm to 2 microns, preferably in the range 1 nm-20 nm. It is envisaged that a suitable membrane material could be cellulose acetate, a polyamide, polysulfone or polyethersulfone, although any suitable material could additionally or alternatively be used, depending upon how long the device 1 is to be used, and how much each device 1 is to cost.

The transmembrane pressure generated by the hydraulic head achieved by the dirty water in the upper compartment 5, is typically within the range of 0.1 to 0.2 bar. The flux of the filter operation is thus relatively low and below the critical flux above which excessive particle deposition occurs on the filter element. It is envisaged that a flux of about 5-10 L/hm² would be achieved by the device 1 but this could rise to about 11 or 12 L/hm² depending on the nature of contamination of the water, and the frequency of backwashing.

The device is thus able to produce, for example, from 120 L to 192 L or 264 L or 288 L within a 24 hour period. This is sufficient to provide the minimum quantity of drinking water to a small group of people, for instance three to ten people.

The bag 3 and all pipes and tubes may be formed from a plastics material that may comprise a recycled plastics material. Such materials render the device 1 relatively light when not filled with water.

The bag material is such that the bag 3 may be folded or rolled for ease of transportation/storage.

In the Appendix hereto some experimental results are provided for tests on the cross-flow membrane in the device 1 of FIG. 1, the cross-flow membrane being a polyimide hollow fibre membrane.

### APPENDIX

In order to examine the necessity of backwashing operation, the membrane fouling tendency over time has been investigated with betonite solution of various concentrations.

Results: Filtering with tap water, permeate flux of around 14 L/hm² was achieved and there was no fouling phenomenon observed with 0.1 g/L betonite solution with the applied operating condition. However, when 0.5 g/L, 2 g/L and 5 g/L solution were applied the membrane fouled seriously in the first few hours, and slightly in the following ones. After the sharp decline, their permeate flux decreased slowly around 8 L/hm², 2 L/hm² and 1 L/hm², respectively which indicates frequent backwashing is preferable to maintain an ideal water flux.

The backwashing operation of 0.5 L filtrates per 0.5 hour has been conducted to determine its effect with betonite solution of various concentrations.

Results: Under the applied backwashing, all water fluxes were significantly enhanced and meanwhile stabled at around 11 L/hm², 7-8 L/hm² and 4-5 L/hm² after each backwashing operation with 0.5 g/L, 2 g/L and 5 g/L betonite solution, respectively. The results illustrate that frequent backwashing performs excellently.

Backwashing can reduce membrane fouling hence increasing water flux, but it consumes clean water to operate. In order to determine the benefit of the backwashing operation, the overall water volumes accumulated after 8-hour filtration with and without back washing have been measured.

Results: From the figure, we can see that the accumulated fluxes with backwashing operation are higher than those without for any solution concentration, especially in the longer term. For 8 hours, the accumulated flux with backwashing reached around 100 L, 55 L and 30 L, respectively with 0.5 g/l, 2 g/l and 5 g/l feed.

Process: Five-day continuous experiments of 8 hours per day have been conducted with 2 g/L betonite solution. In the first three days, backwashing of 0.5 L filtrates/0.5 h was applied without backwashing operation before the experiments each day; in the last two days backwashing of 0.3 L filtrates/0.5 h was operated with backwashing before the experiments.

Results: From the results, we can see backwashing before experiments each day can prevent permeate declining between days, and compared to backwashing of 0.5 L/0.5 h, the effect of 0.3 l/0.5 h is less ideal as in the fourth and fifth days the permeates decreased after each backwashing instead of stabling which shows the effect of backwashing is related to the water volume used.

Results: The selected cartridge can repeat its performance over days with appropriate backflushing and the device can last at least thirty days.

Results: No significant membrane degradation.

1. A portable water purification device comprising a dirty water inlet operative to comprise a head of dirty water, water filtration means connected to the dirty water inlet, and a clean water tank connected to an outlet of the water filtration means, the dirty water inlet, when the device is in an operational condition, being arranged relative to the clean water tank and the water filtration means such that, in use of the device, dirty water is forced through the water filtration means and into the clean water tank by the gravitational force generated from the head of dirty water in the dirty water inlet, the water filtration means comprising a cross-flow membrane filter in which the gravitational force from the head of dirty water also forces dirty water across the cross-flow membrane filter so as to force contaminants out of the filter.

2. The device of claim 1 further comprising a dirty water inlet tank that feeds, in use, dirty water to the dirty water inlet.

3. The device of claim 2 wherein the dirty water inlet tank and the clean water tank comprise internal reinforcement means.

4. The device of claim 2 wherein the shape of the dirty water inlet tank substantially mirrors that of the clean water tank such that the device is substantially balanced in normal use.

5. The device of claim 1 wherein the device comprises a clean water supply pipe connected to the clean water tank and operative to enable clean water to be discharged from the clean water tank.

6. The device of claim 5 wherein the clean water supply pipe is capable of being positioned such that its free end is above the dirty water level in the dirty water inlet tank when in an operational condition.

7. The device of claim 1 wherein the clean water tank comprises venting means operative to relieve pressure build up within the clean water tank.

8. The device of claim 7 wherein the venting means comprises a venting tube connected between the clean water tank and the clean water supply pipe.

9. The device of claim 1 wherein the dirty water inlet and the clean water tank are arranged such that when the clean water tank is full of clean water, the flow of dirty water through the filter of the filtration means automatically stops.

10. The device of claim 2 wherein the dirty water inlet tank comprises a base which is inclined when the device is in an operational condition such that particles of matter suspended in the dirty water flow down the base so as to be separated from the water.

11. The device of claim 10 wherein the base is inclined between 5° and 85° from the horizontal when the device is in an operational condition.

12. The device of claim 10 wherein the base is inclined between 20° and 70° from the horizontal when the device is in an operational condition.

13. The device of claim 10 wherein the base is inclined at between 30° and 60° from the horizontal when the device is in an operational condition.

14. The device of claim 1 comprising a sump into which, in use, the separated particles collect.

15. The device of claim 14 wherein the sump is positioned below the dirty water inlet to the water filtration means.

16. The device of claim 14 wherein the sump is provided with a sump outlet that functions, in use, as a flow restrictor operative to enable continuous but controlled outlet of the separated particles from the sump.

17. The device of claim 16 wherein the sump outlet is adjustable for different flow rates.

18. The device of claim 2 wherein the dirty water inlet is positioned below the lower end of the base of the dirty water inlet tank.

19. The device of claim 18 wherein the dirty water inlet is positioned below a constriction of the dirty water inlet tank, the constriction being operative to induce a converging flow of dirty inlet water after the constriction so as to minimise the ingress of suspended particles entering the dirty water inlet of the water filtration means.

20. The device of claim 2 wherein the dirty water inlet is positioned above the lower end of the base such that in use separated particles flow down the base and the remaining water flows up the base and into the dirty water inlet.

21. The device of claim 2 wherein the base of the dirty water inlet tank comprises a particle separator comprising an inclined planar element spaced above the base so as to define a channel therebetween, the dirty water inlet being open to the channel.

22. The device of claim 1 wherein the device further comprises back wash means connected between the clean water tank and the water filtration device and operative to force clean water back through the water filtration device to dislodge trapped particles from the water filtration device.

23. The device of claim 22 wherein the back wash means comprises a bladder, compression of the bladder forcing clean water through the water filtration device.

24. The device of claim 23 wherein the bladder is conical.

25. The device of claim 1 wherein the water filtration means comprises a hollow fibre membrane type filter mounted in an elongate filter housing.

26. The device of claim 25 wherein the filter is formed from a membrane material having a continuous operational life span of less than three months.

27. The device of claim 25 wherein the filter housing is mounted horizontally, when the device is in an operational condition.

28. The device of claim 25 wherein the filter housing is mounted vertically, when the device is in an operational condition.

29. The device of claim 25 wherein the filter housing is mounted at an angle inclined from the horizontal, when the device is in an operational condition.

30. The device of claim 1 wherein the dirty water inlet and the clean water tank are formed from a flexible plastics material.

31. The device of claim 1 wherein the device is collapsible.

32. The device of claim 31 wherein the device can be collapsed by folding the device onto itself.

33. The device of claim 31 wherein the device can be collapsed by furling the device onto itself.

34. The device of claim 1 wherein the device comprises a bag.

35. The device of claim 34 wherein the bag is substantially rectangular when in an operational condition.
